(19) United States
(12) Patent Application Publication
(10) Pub. No.: US 2008/0120894 A1
(43) Pub. Date: May 29, 2008

(54) Fish hook remover

(76) Inventor: Norman L. Broadnax, Marietta, GA (US)

Correspondence Address: JOHN L. JAMES, P.O. BOX 2025, MARIETTA, GA, 30061-2025, US

(21) Appl. No.: 11/605,994

(22) Filed: Nov. 29, 2006

(51) Int. Cl. A01K 97/18

(52) U.S. Cl. 43/53.5

(57) ABSTRACT

A tool for removing a fish hook has an elongated handle with a longitudinal axis, top and bottom end portions and a middle portion intermediate the top and bottom end portions. A shoulder connected to the top end portion has first and second portions offset from the longitudinal axis. A first hook engaging member joined to the first portion of the shoulder angularly extends toward the longitudinal axis. The first hook engaging member has an inner surface defining a plurality of grooves therein adapted to engage the fish hook to facilitate removal thereof from the fish's mouth.

### TECHNICAL FIELD OF THE INVENTION

This invention relates generally to removing a hook from the mouth of a fish, and, more particularly, to a hand tool for aiding in removing the hook.

### BACKGROUND OF THE INVENTION

When fishing using a hook and line, one of the chores for the fisherman is removing the fishing hook from the mouth of the fish. This seemingly simple task is complicated by the size and shape of the hook, the size and shape of the fish, and the condition of the fisherman's hands. The hook normally includes a barb that prevents the hook from being easily pulled from the mouth of the fish. When the fish is to be released, as sometimes required or desired, the embedded barb must be dislodged from the soft tissue of the fish without causing irreparable harm. This is especially difficult in situations where the fish has deeply swallowed the hook. Even if the fish will not be released, the hook must still be removed so that the fisherman can continue fishing.

Because the slippery surface of the fish does not allow one to leverage the hook from the mouth by using one's fingers alone, a fisherman often resorts to using regular common pliers and needle nose pliers to remove the hook. The use of common pliers is not only cumbersome and ill-suited to the hook removal process, but can also damage the hook. This can be extremely frustrating to the fisherman when time is of the essence, and can be expensive for some types of hooks. It is therefore desirable to have a tool that effectively removes a hook with minimal damage to the hook and fish.

Fishing is an activity that can be enjoyed by persons of all ages; however, an aged person or a person with arthritis or with other diseases may have difficulty removing a fish hook unassisted because of a loss of dexterity or strength. Accordingly, it is highly desirable to have a simple tool for removing the hook that does not require a great deal of digital dexterity to manipulate.

Another problem encountered in removing the hook is that the fishing line often gets in the way as the hook remover is maneuvered into position. The fishing line may also become damaged by the stretching and twisting of the hook remover, especially if the line is rubbed across the very fine, sharp teeth of some fish. Accordingly, it is highly desirable to have a tool for removing the hook that engages the line to keep it out of harms way.

### SUMMARY OF THE INVENTION

The present invention is directed to overcoming one or more of the problems set forth above. Briefly summarized, according to one aspect of the present the invention, a tool for removing a fish hook from a fish's mouth comprises: an elongated handle having a longitudinal axis, top and bottom end portions and a middle portion intermediate the top and bottom end portions; a shoulder connected to the top end portion having first and second portions offset from the longitudinal axis; and a first hook engaging member joined to the first portion of the shoulder angularly extending toward the longitudinal axis. The first hook engaging member has a tip, an inner surface and an outer surface. The inner surface has a curved portion adapted to engage the fish hook to facilitate removal thereof from the fish's mouth. The inner surface and the outer surface define a furrow extending from the outer surface about the inner surface.

A second hook engaging member, with a tip, is joined to the second portion of the shoulder and angularly extends toward the longitudinal axis. The tips are spaced from one another and adapted to receive the shank of the hook therebetween. The inner surfaces of the hook engaging members each have a distal portion defining a tooth to aid is dislodging the hook. Similarly, the junctions of the shoulder and the hook engaging members define grooves to aid in dislodging the hook. The tool can be held in either hand and easily manipulated with one hand to dislodge the hook.

According to another aspect of the present invention, a plier-like tool for removing a fish hook from a fish's mouth comprises: first and second elongated members each having a longitudinal axis, a handle portion, a head portion and a pivot portion intermediate the handle and head portions with the elongated members being pivotally connected to one another at their pivot portions so that the head portions move between a closed position at which the head portions abut one another and an open position at which the head portions are spaced from one another; first and second shoulders each having first and second portions offset from a respective longitudinal axis and each being connected to a respective one of the head portions of each of the elongated members; first and second head members each respectively joined to the first and second portions of the first shoulder and angularly extending toward the longitudinal axis of the first elongated member with the first and second head members each defining an inner surface with a plurality of grooves therein adapted to engage the fish hook to facilitate removal thereof from the fish's mouth; and third and fourth head members each respectively joined to the first and second portions of the shoulder and angularly extending toward the longitudinal axis of the second elongated member with the third and fourth head members each defining an inner surface with a plurality of grooves therein adapted to engage the fish hook to facilitate removal thereof from the fish's mouth.

Each inner surface of each head member has a distal portion defining a tooth to aid in hook removal. A groove of each of the plurality of grooves of each the head members has a depth sufficient to receive the shank of the fish hook therein to grip the hook to aid in removal thereof. The plier-like tool can be held in either hand and easily manipulated with one hand to dislodge the hook.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a front view of a preferred embodiment of a fisherman's plier tool incorporating a tool for removing a fish hook according to the present invention.

FIG. 2 is a side view of the tool of FIG. 1.

FIG. 3 is a diagram of a fish hook.

FIG. 4 is a top view of the tool of FIG. 1 with the jaws of the head closed.

FIG. 5 is a top view of the tool of FIG. 1 with the jaws of the head open.

FIG. 6 is a somewhat enlarged inside view of the right half of the head of the tool of FIG. 1 showing hook gripping grooves.

FIG. 7 is a somewhat enlarged inside view of the left half of the head of the tool of FIG. 1 showing hook gripping grooves.

FIG. 8 is an inside view of one half of the head of a fishing tool similar to FIGS. 6-7, but illustrating another embodiment.

FIG. 9 is an inside view of one half of the head of a fishing tool similar to FIG. 8, but illustrating another embodiment.

FIG. 10 is another preferred embodiment of a tool for dislodging and removing a fish hook according to the present invention.

FIG. 11 is another preferred embodiment of a head piece for a tool for dislodging and removing a fish hook according to the present invention.

### DETAILED DESCRIPTION OF THE PREFERRED EMBODIMENTS

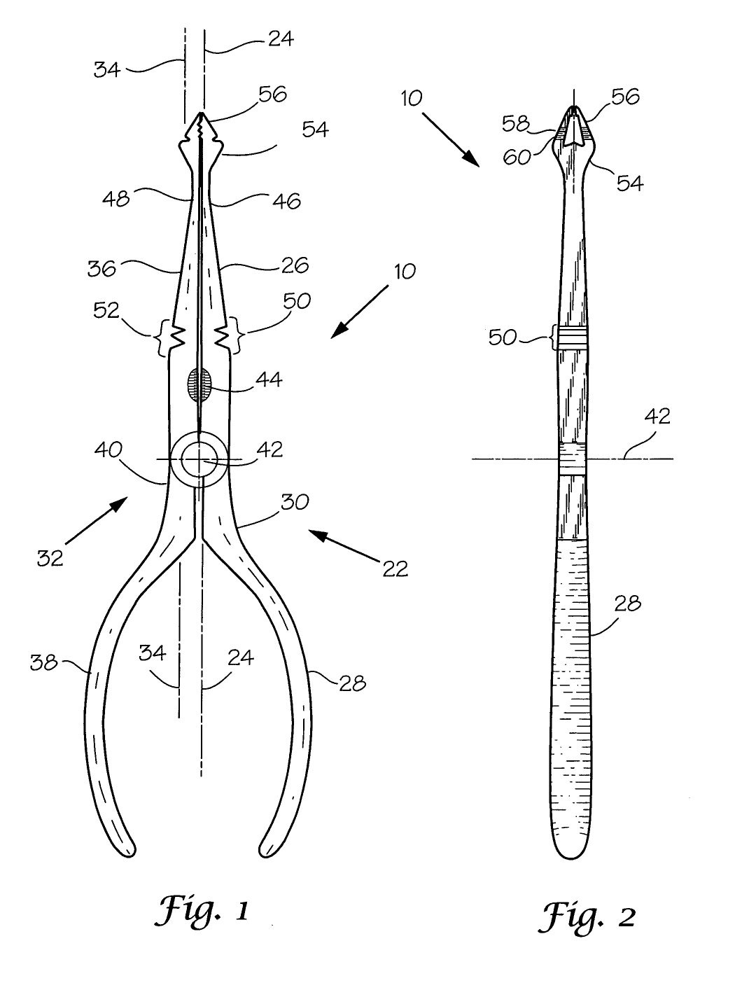

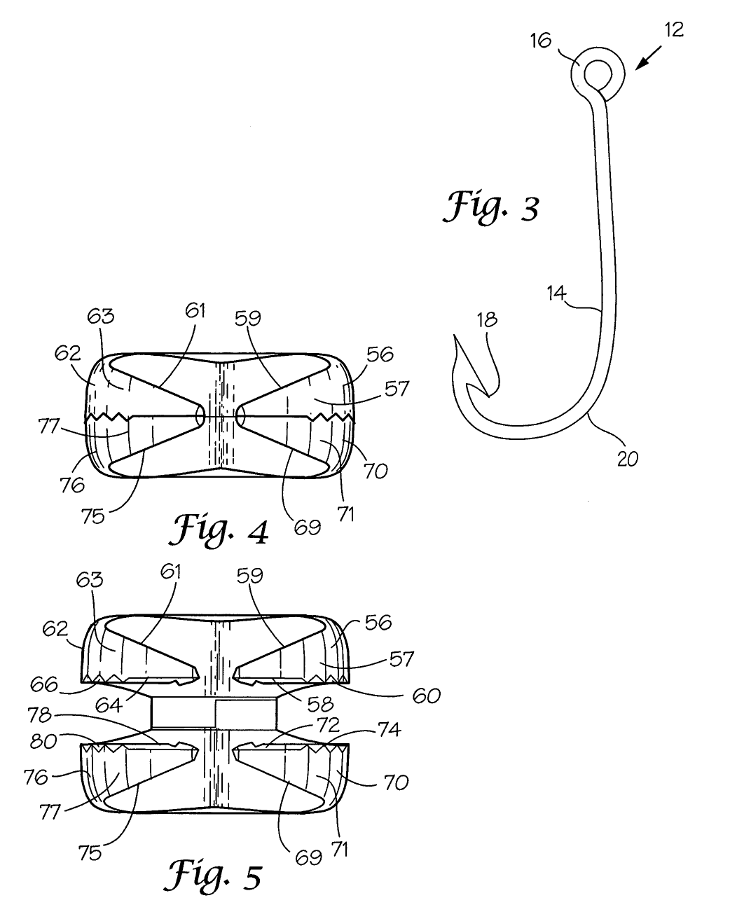

Referring to FIGS. 1-3, a plier-like tool 10 for dislodging and removing a fish hook 12 from a fish's mouth. Hook 12 typically has a shank 14 with an eyelet 16 on one end of shank 14 and a barb 18 on the other end, and has a curved portion 20 between shank 14 and barb 18. Barbless hooks can also used for fishing where the fish is to be released with minimal injury.

Tool 10 has a first elongated handle member 22 that has a first longitudinal axis 24, head or top end portion 26, and handle or bottom end portion 28 and a middle portion 30 intermediate the head and handle portions 26, 28. A second elongated handle member 32 has a second longitudinal axis 34, top or head portion 36, bottom end portion 38 and a middle portion 40 intermediate the head and handle portions 36, 38. The intermediate portions of the first and second elongated handle members 30, 40 are pivotally connected to one another at pivot point 42.

Referring to FIGS. 4-5, the elongated handle members 22, 32 are pivotally connected to one another at pivot point 42 so that the head portions 26, 36 move between an open position and a closed position. At the open position, the head portions are spaced one from the other to allow entrance of hook 12 for contact with the interior surfaces of the head portions. At the closed position, head portions 26, 36 abut one another so that the shank 14 of hook 12 can be firmly grasped for removal.

Referring to FIGS. 1-2, tool 10 preferably has a cutter 44 above pivot point 42, and plier blades 46, 48 above cutter 44. Plier blades 46, 48 are preferably elongated blades like the blades of needle nose pliers. An exterior surface of the top end portion 28 of the first elongated handle member 22 defines a groove 50 preferably above pivot point 42 in blade 46. Similarly, an exterior surface of the top end portion 38 of the first elongated handle member 32 defines a groove 52 preferably above pivot point 42 in blade 48. Grooves 50, 52 preferably extend along the curved surfaces of the sides or edges of blades 46, 48. Grooves 50, 52 are preferably aligned with one another to function as a single groove about the blades 46, 48 that aids with the line when removing a hook. Alternatively, the grooves can be vertically offset from one another and sized differently to accommodate various line diameters.

Referring now to FIGS. 1-7, a first shoulder member 54 is connected to the top end portion 26 of the first elongated handle member 22 and has first and second shoulder portions offset from the first longitudinal axis 24. A first head member or hook engaging member 56 is joined to the first shoulder portion and angularly extends toward first longitudinal axis 24. First hook engaging member 56 has an inner surface and an outer surface. The inner surface defines a plurality of upper grooves 58 and lower grooves 60 therein adapted to engage the fish hook to facilitate removal thereof from the fish's mouth. Upper grooves 58 are generally straight grooves adapted to engage the shank 14 of the hook 12 and are located near the upper end or tip of the tool 10. On the other hand, lower grooves 60 are generally curved to aid in grasping the curved portion 20 of hook 12. Lower grooves 60 are generally located away from upper end or tip of the tool 10 near the shoulder.

A second head member or hook engaging member 62 is joined to the second shoulder portion and angularly extends toward the first longitudinal axis 24. Second hook engaging member 62 has an inner surface and an outer surface. The inner surface defines a plurality of upper grooves 64 and lower grooves 66 therein adapted to engage the fish hook to facilitate removal thereof from the fish's mouth. Upper grooves 64 are generally straight grooves adapted to engage the shank 14 of the hook 12 and are located near the upper end or tip of the tool 10. On the other hand, lower grooves 66 are generally curved to aid in grasping the curved portion 20 of hook 12. Lower grooves 66 are generally located away from upper end or tip of the tool 10 near the shoulder.

A second shoulder member 68 is connected to the top end portion 36 of the second elongated handle member 32 and has third and fourth shoulder portions offset from the second longitudinal axis 34. A third head member or hook engaging member 70 is joined to the third shoulder portion and angularly extends toward second longitudinal axis 34. Third hook engaging member 70 has an inner surface and an outer surface. The inner surface defines a plurality of upper grooves 72 and lower grooves 74 therein adapted to engage the fish hook to facilitate removal thereof from the fish's mouth. Upper grooves 72 are generally straight grooves adapted to engage the shank 14 of the hook 12 and are located near the upper end or tip of the tool 10. On the other hand, lower grooves 74 are generally curved to aid in grasping the curved portion 20 of hook 12. Lower grooves 74 are generally located away from upper end or tip of the tool 10 near the shoulder.

A fourth head member or hook engaging member 76 is joined to the fourth shoulder portion and angularly extends toward second longitudinal axis 34. Fourth hook engaging member 76 has an inner surface and an outer surface. The inner surface defines a plurality of upper grooves 78 and lower grooves 80 therein adapted to engage the fish hook to facilitate removal thereof from the fish's mouth. Upper grooves 78 are generally straight grooves adapted to engage the shank 14 of the hook 12 and are located near the upper end or tip of the tool 10. On the other hand, lower grooves 80 are generally curved to aid in grasping the curved portion 20 of hook 12. Lower grooves 80 are generally located away from upper end or tip of the tool 10 near the shoulder.

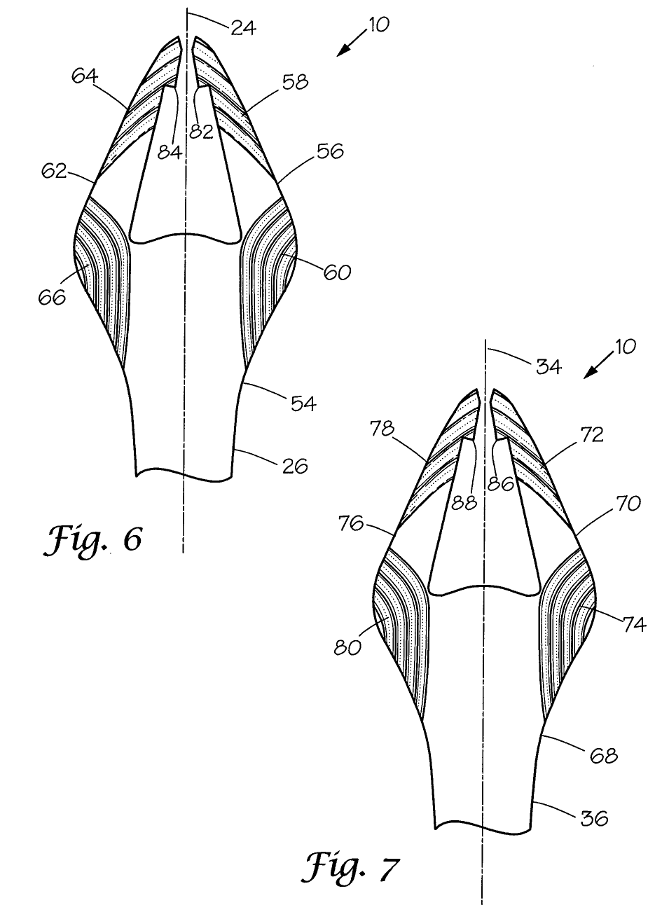

Referring to FIGS. 6-7, part of the difficulty of removing hooks is the inability to get a grip with bare fingers or leverage the hook with a tool. To engage the hook, each head member or hook engaging member has a downwardly projecting tooth that can contact the hook to provide a nudge to dislodge it. Thus, first head member or hook engaging member 56 has tooth 82 disposed on a distal end portion near the tip of the tool, and second head member or hook engaging member 62 has tooth 82 similarly disposed. Third head member or hook engaging member 70 has tooth 86 disposed on a distal end portion near the tip of the tool, and fourth head member or hook engaging member 76 has tooth 88 similarly disposed.

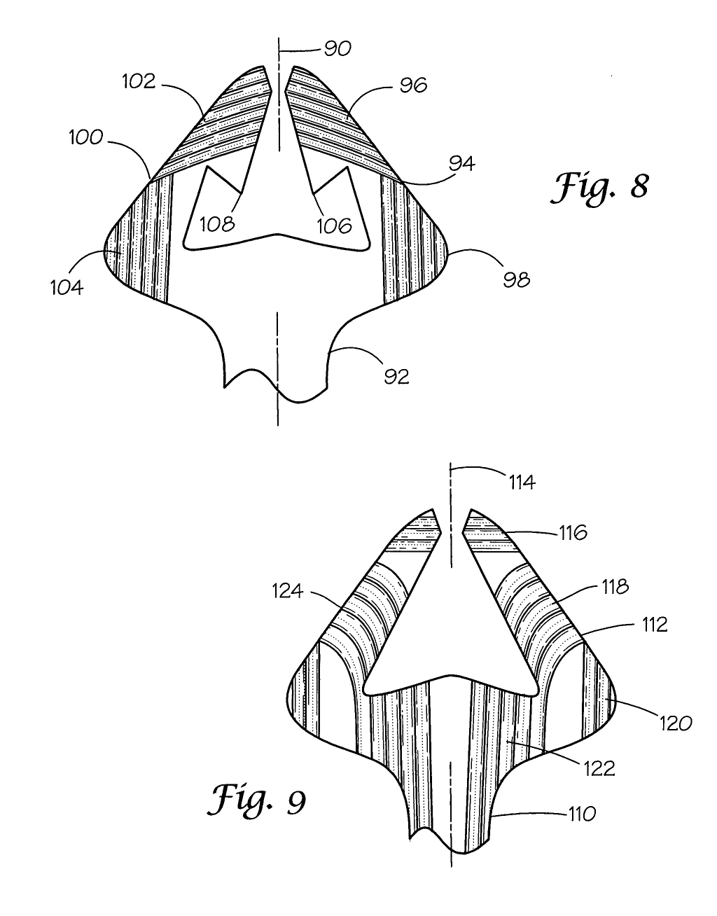

Referring to FIG. 8, another embodiment of the invention has a shoulder member 92 connected to the top end portion of an elongated handle member and has first and second shoulder portions offset from the first longitudinal axis. A first head member or hook engaging member 94 is joined to the first shoulder portion and angularly extends toward a longitudinal axis 90. First hook engaging member 94 has an inner surface and an outer surface. The inner surface defines a plurality of upper grooves 96 and lower grooves 98 therein adapted to engage the fish hook to facilitate removal thereof from the fish's mouth. Upper grooves 96 are generally straight grooves adapted to engage the shank of a hook and are located near the upper end or tip of the tool. Lower grooves 98 are generally straight grooves located away from upper end or tip of the tool near the shoulder. As illustrated, upper grooves 96 are disposed horizontally while lower grooves 98 are disposed vertically. By this construction, grooves are available to grasp the hook regardless of the orientation of the hook.

A second head member or hook engaging member 100 is joined to the second shoulder portion and angularly extends toward the longitudinal axis 90. Second hook engaging member 100 also has an inner surface and an outer surface. The inner surface defines a plurality of upper grooves 102 and lower grooves 104 therein adapted to engage the fish hook to facilitate removal thereof from the fish's mouth. Upper grooves 102 are generally straight grooves adapted to engage the shank of a hook and are located near the upper end or tip of the tool. Lower grooves 104 are generally straight grooves located away from upper end or tip of the tool near the shoulder. As illustrated, upper grooves 102 are disposed horizontally while lower grooves 104 are disposed vertically. By this construction, grooves are available to grasp the hook regardless of the orientation of the hook. The shoulder member 92 with attached head members 94, 100 cooperate with a facing shoulder member with attached head members on the plier-like tool.

Again, some of the difficulty of removing hooks arises from the inability to get a grip with bare fingers or leverage the hook with a tool. To engage the hook, each head member or hook engaging member has a downwardly projecting tooth that can contact the hook to provide a nudge to dislodge it. Thus, first head member or hook engaging member 94 has tooth 106 disposed on a distal end portion near the tip of the tool, and second head member or hook engaging member 100 has tooth 108 similarly disposed.

Referring to FIG. 9, another embodiment of the invention has a shoulder member 110 connected to the top end portion of an elongated handle member and has first and second shoulder portions offset from the first longitudinal axis. A first head member or hook engaging member 112 is joined to the first shoulder portion and angularly extends toward a longitudinal axis 114. First hook engaging member 112 has an inner surface and an outer surface. The inner surface defines a plurality of upper grooves 116, intermediate or middle grooves 118, lower grooves 120 and shoulder grooves 122 therein adapted to engage the fish hook to facilitate removal thereof from the fish's mouth. As illustrated, upper grooves 116 are disposed horizontally while shoulder grooves 122 are disposed vertically. Intermediate grooves 114 are generally horizontally and curved. Lower grooves 120 are generally straight at locations distal from the axis but curve as they are disposed closer to the axis. By this construction, grooves are available to grasp or engage the hook regardless of the orientation of the hook.

A second head member or hook engaging member 124 is joined to the second shoulder portion angularly extending toward the longitudinal axis and is a mirror image of first hook engaging member 112. Shoulder member 110 with attached head members 112, 124 cooperate with a facing shoulder member with attached head members on the plier-like tool.

It can now be appreciated that a plier-like tool for removing a fish hook has been presented. The tool has a first handle member with a first axis, top and bottom end portions and a middle portion. A second handle member has a second axis, top and bottom end portions and a middle portion. The middle portions are pivotally connected to each other so that the tool can be maneuvered with one hand, like a pair of pliers, while the other hand remains free to manage the fish or the line.

A first shoulder connected to the top end portion of the first handle member has first and second portions offset from the first longitudinal axis. A first hook engaging member is joined to the first portion of the first shoulder and angularly extends toward the first longitudinal axis to help form a gap for receiving the hook. The grooved inner surface is adapted to engage and grip the hook to facilitate removal thereof from the fish's mouth. The second hook engaging member helps form the gap with the first hook engaging member. The size of the gap will vary with the size of the hook. For best results, the gap should preferably be about one and one half to two times the hook shaft diameter. Smaller gaps require more eye-hand coordination and larger gaps provide room for the hook to move about which is undesirable.

A second shoulder with third and fourth hook engaging members cooperate with the first shoulder and hook engaging members to capture and hold hooks between the grooved surfaces. Exterior surfaces of the top end portions of the handle members define a groove for managing fishing line. Each inner surface of each fish hook engaging members has a distal portion defining a tooth for aiding in hook removal.

The tool effectively dislodges the hook with minimal injury to the fish and with minimal damage to the hook so that the hook can be used again. The tool is as easy to use as a pair of pliers but does not require the hand strength or finger dexterity that regular pliers require. Some grooves on the tool engage the fishing line to keep the line out of the way while the hook is being dislodged and removed. Other grooves receive the shank or other portion of the hook so that the hook can be pushed, pulled, twisted or otherwise manipulated to dislodge the hook from the fish's mouth.

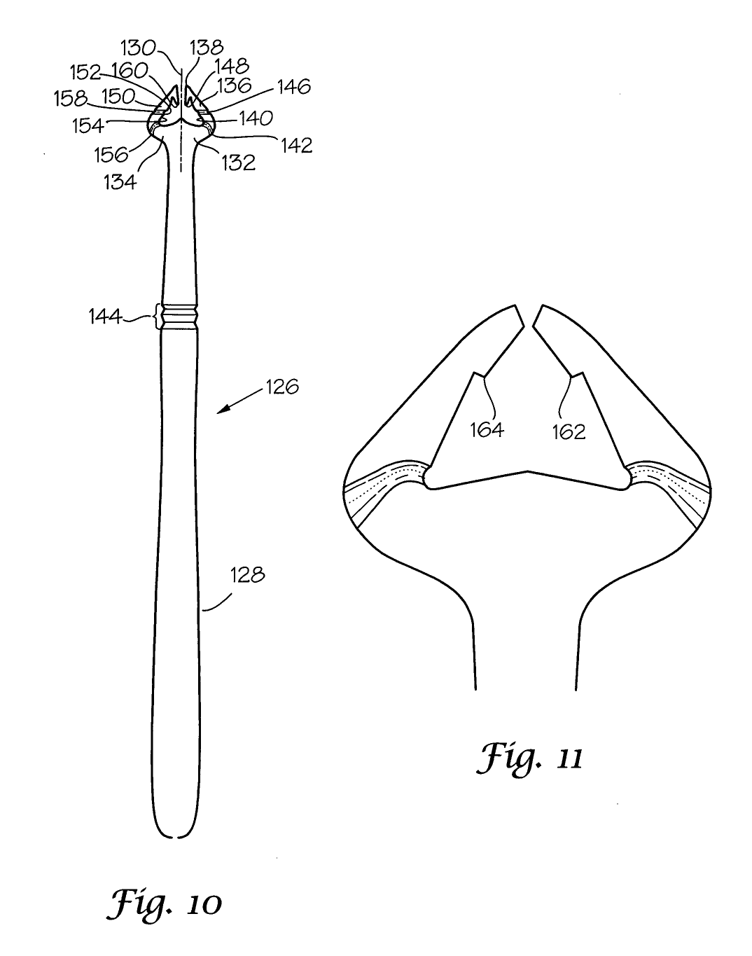

Referring now to FIG.10, a tool 126 for removing a fish hook from a fish's mouth has an elongated handle 128 with a longitudinal axis 130, top and bottom end portions and a middle portion intermediate the top and bottom end portions. A shoulder connected to the top end portion of handle 128 has first and second portions 132, 134 offset from the longitudinal axis. A first head member or hook engaging member 136 is attached to the first portion 132 of the shoulder and angularly extends toward longitudinal axis 130. First hook engaging member 136 has a tip 138, an inner surface and an outer surface. The inner surface has a curved portion 140 adapted to engage the fish hook to facilitate removal thereof from the fish's mouth. The inner surface and the outer surface preferably define a groove or furrow 142 extending from the outer surface about the inner surface. The junction of first shoulder portion 132 and the first hook engaging member 136 define part of groove or furrow 142.

An exterior surface of the middle portion of handle 128 defines a groove 144 to assist with line management. The exterior surface of the first hook engaging member 136 preferably defines a groove 146 to aid in gripping and leveraging the hook. The inner surface of the first fish hook engaging member 136 has a distal portion defining a downwardly projecting tooth 148 for leveraging the hook.

A second head member or hook engaging member 150 is attached to the second portion 134 of the shoulder and angularly extends toward longitudinal axis 130. Second hook engaging member 150 has a tip 152, an inner surface and an outer surface. The inner surface has a curved portion 154 adapted to engage the fish hook to facilitate removal thereof from the fish's mouth. The inner surface and the outer surface define a groove or furrow 156 extending from the outer surface about the inner surface. The junction of second shoulder portion 134 and the second hook engaging member 150 define part of groove or furrow 156. The exterior surface of the second hook engaging member 150 preferably defines a groove 156 to aid in gripping and leveraging the hook. The inner surface of the second fish hook engaging member 150 has a distal portion defining a downwardly projecting tooth 160 for leveraging the hook. Tips 138, 152 are spaced from one another and adapted to receive the shank of the hook therebetween. FIG. 11 is an alternate configuration for the head of the tool featuring blunter teeth 162, 164 and fewer grooves.

It can now be appreciated that a simple tool for removing a fish hook from a fish's mouth has been presented. The tool features a handle with a hook engaging member. The handle has grooves for managing the fishing line. The hook engaging member has grooves for receiving the hook to facilitate pushing, pulling, twisting or otherwise manipulating the hook to dislodge it. The simple tool has the advantage of being very simple, while the plier-like tool has the advantages that pliers and cutters provide.

While the invention has been described with particular reference to the preferred embodiments, it will be understood by those skilled in the art that various changes may be made and equivalents may be substituted for elements of the preferred embodiments without departing from invention. For example, while it is contemplated that the tool will be constructed of stainless steel or corrosion resistant metals, it could incorporate plastic or ceramic materials or materials to aid flotation. And while the invention has been described with reference to a single hook, it is also suitable for use with double, treble or other configurations of hooks.

As is evident from the foregoing description, certain aspects of the invention are not limited to the particular details of the examples illustrated, and it is therefore contemplated that other modifications and applications will occur to those skilled in the art. For example, while only certain groove orientations have been shown, there is no limit to the configurations possible that would aid in receiving or grasping the hook. Also, there is no set shape or orientation for the teeth. It is accordingly intended that the claims shall cover all such modifications and applications as do not depart from the true spirit and scope of the invention.

### ELEMENT LIST

10 plier-like tool for removing a fish hook
12 fish hook
14 shank
16 eyelet
18 barb
20 curved portion
22 first elongated handle member
24 first longitudinal axis
26 head or top end portion
28 handle or bottom end portion
30 middle portion
32 second elongated handle member
34 second longitudinal axis
36 top or head portion
38 bottom end portion
40 middle portion
42 pivot
44 cutter
46, 48 plier blades
50, 52 grooves
54 first shoulder member
56 first hook engaging member
58/60 upper/lower grooves
62 second head member or hook engaging member
64/66 upper/lower grooves
68 second shoulder member
70 third head member or hook engaging member
72/74 upper/lower grooves
76 fourth head member or hook engaging member
78/80 upper/lower grooves
82-84-86-88 teeth
90 longitudinal axis
92 shoulder member
94 first head member or hook engaging member
96/98 upper/lower grooves
100 second head member or hook engaging member
102/104 upper/lower grooves
106, 108 teeth
110 shoulder member
112 first head member or hook engaging member
114 longitudinal axis
116/118/120 upper/intermediate or middle/lower grooves
122 shoulder grooves
124 second head member or hook engaging member
126 tool for removing a fish hook
128 elongated handle
130 longitudinal axis
132/134 first/second shoulder portion
136 first head member or hook engaging member
138 tip
140 curved portion
142/144/146 groove or furrow/grooves/grooves
148 tooth
150 second head member or hook engaging member
152 tip
154 curved portion
156/158 groove or furrow/groove
160 downwardly projecting tooth
162, 164 teeth

1. A tool for removing a fish hook from a fish's mouth, said fish hook having a shank, said tool comprising:
an elongated handle having a longitudinal axis, top and bottom end portions and a middle portion intermediate said top and bottom end portions;
a shoulder connected to said top end portion and having first and second portions offset from said longitudinal axis;
a first hook engaging member joined to said first portion of said shoulder and angularly extending toward said longitudinal axis, said first hook engaging member having a tip, an inner surface and an outer surface, said inner surface having a curved portion adapted to engage said fish hook to facilitate removal thereof from the fish's mouth, said inner surface and said outer surface defining a furrow extending from said outer surface about said inner surface.

2. A tool, as set forth in claim 1, wherein an exterior surface of said middle portion of said handle defines a groove.

3. A tool, as set forth in claim 1, wherein said inner surface of said first fish hook engaging member has a distal portion defining a downwardly projecting tooth.

4. A tool, as set forth in claim 1, including:
a second hook engaging member joined to said second portion of said shoulder and angularly extending toward said longitudinal axis, said second hook engaging member having a tip, an inner surface and an outer surface, said inner surface having a curved portion adapted to engage said fish hook to facilitate removal thereof from the fish's mouth, said inner surface and said outer surface defining a furrow extending from said outer surface about said inner surface.

5. A tool, as set forth in claim 4, wherein said tips are spaced from one another and adapted to receive the shank of the hook therebetween.

6. A tool, as set forth in claim 1, wherein the junction of said shoulder and said first hook engaging member define a groove.

7. A tool, as set forth in claim 1, wherein said exterior surface of said first hook engaging member defines a groove.

8. A plier-like tool for removing a fish hook from a fish's mouth, said fish hook having a shank, said tool, comprising:
a first and second elongated members each having a longitudinal axis, a handle portion, a head portion and a pivot portion intermediate said handle and head portions, said elongated members being pivotally connected to one another at their pivot portions so that said head portions move between a closed position at which said head portions abut one another and an open position at which said head portions are spaced from one another;
a first and second shoulder each connected to a respective one of said head portion of each of said elongated members, each said shoulder having first and second portions offset from a respective said longitudinal axis;
a first and second head members each respectively joined to said first and second portions of said first shoulder and angularly extending toward said longitudinal axis of said first elongated member, said first and second head members each defining an inner surface and an outer surface, said inner and outer surfaces having a plurality of grooves therein adapted to engage said fish hook to facilitate removal thereof from the fish's mouth;
a third and fourth head members each respectively joined to said first and second portions of said second shoulder and angularly extending toward said longitudinal axis of said second elongated member, said third and fourth head members each defining an inner surface and an outer surface, said inner and outer surfaces having a plurality of grooves therein adapted to engage said fish hook to facilitate removal thereof from the fish's mouth.

9. A tool, as set forth in claim 8, wherein each said head portion of said elongated members defines a groove.

10. A tool, as set forth in claim 8, wherein each said inner surface of each said head member has a distal portion defining a tooth.

11. A tool, as set forth in claim 8, wherein a groove of each said plurality of grooves of each said head member has a depth sufficient to receive said shank of said fish hook therein.

12. A plierlike tool for removing a fish hook, comprising:
a first elongated handle member having a first longitudinal axis, top and bottom end portions and a middle portion intermediate said top and bottom end portions;
a first shoulder connected to said top end portion of said first elongated handle member, said first shoulder having first and second portions offset from said first longitudinal axis;
a first hook engaging member joined to said first portion of said first shoulder and angularly extending toward said first longitudinal axis, said first hook engaging member having an inner surface and an outer surface, said surfaces defining a plurality of grooves therein adapted to engage said fish hook to facilitate removal thereof from the fish's mouth;
a second hook engaging member joined to said second portion of said first shoulder and angularly extending toward said first longitudinal axis, said second hook engaging member having an inner surface and an outer surface, said surfaces defining a plurality of grooves therein adapted to engage said fish hook to facilitate removal thereof from the fish's mouth;
a second elongated handle member having a second longitudinal axis, top and bottom end portions and a middle portion intermediate said top and bottom end portions, said intermediate portions of said first and second elongated handle members being pivotally connected to one another;
a second shoulder connected to said top end portion of said second elongated handle member, said second shoulder having third and fourth portions offset from said second longitudinal axis;
a third hook engaging member joined to said third portion of said second shoulder and angularly extending toward said second longitudinal axis, said third hook engaging member having an inner surface and an outer surface, said inner surface defining a plurality of grooves therein adapted to engage said fish hook to facilitate removal thereof from the fish's mouth; and
a fourth hook engaging member joined to said fourth portion of said second shoulder and angularly extending toward said second longitudinal axis, said second hook engaging member having an inner surface and an outer surface, said inner surface defining a plurality of grooves therein adapted to engage said fish hook to facilitate removal thereof from the fish's mouth.

13. A tool, as set forth in claim 12, wherein an exterior surface of said top end portion of said first elongated handle member defines a groove.

14. A tool, as set forth in claim 12, wherein an exterior surface of said top end portion of said second elongated handle member defines a groove.

15. A tool, as set forth in claim 12, wherein each said inner surface of each of said fish hook engaging members has a distal portion defining a tooth.

16. A tool, as set forth in claim 12, wherein a groove of each said plurality of grooves of said hook engaging members is spaced from an adjacent groove to receive said contoured portion of said fish hook therein.
